(19) United States
(12) Patent Application Publication
(10) Pub. No.: US 2013/0100876 A1
(43) Pub. Date: Apr. 25, 2013

(54) Method, Base Station, Mobility Management Entity, and System for Implementing Service Processing

(71) Applicant: Huawei Technologies Co., Ltd., Shenzhen (CN)

(72) Inventor: Chengdong He, Shenzhen (CN)

(73) Assignee: HUAWEI TECHNOLOGIES CO., LTD., Shenzhen (CN)

(21) Appl. No.: 13/712,483

(22) Filed: Dec. 12, 2012

Related U.S. Application Data
(63) Continuation of application No. PCT/CN2010/073894, filed on Jun. 12, 2010.

(51) Int. Cl. H04W 88/04

(52) U.S. Cl. CPC H04W 88/04
USPC 370/315

(57) ABSTRACT

A method, a base station, a mobility management entity, and a system can be used for implementing service processing. The method includes acquiring the type of a subscribed user. If the type of the subscriber user is a UE, an S1-AP response message is sent to a Relay node and an access stratum AS security mechanism and/or a network domain security mechanism are used with the Relay node. If the type of the subscriber user is a relay base station Relay, radio resource control RRC reconfiguration process is initiated with the Relay node and an AS security mechanism is used with the Relay node.

This application is a continuation of International Application No. PCT/CN2010/073894, filed on Jun. 12, 2010, which is hereby incorporated by reference in its entirety.

### TECHNICAL FIELD

The present invention relates to the wireless communications field, and in particular, to a method, a base station, a mobility management entity, and a system for implementing service processing.

### BACKGROUND

On a wireless mobile communication network, the communication protocol between a UE (User Equipment, user equipment) and an eNodeB (Evolved Node B, evolved NodeB) is the air interface protocol, and the communication protocol between the eNodeB and an MME (Mobile Management Entity, mobility management entity) is the S1-AP protocol.

A Relay (relay base station) node is introduced to the network and the eNodeB is expanded to a DeNB (Donor eNodeB, donor eNodeB) at the same time, so as to increase the coverage of a base station at some blind spots (such as islands and forests).

The Relay node may be deployed on the network as a base station and it can be connected to a UE. The communication protocol between the relay node and the UE is the air interface protocol, the communication protocol between the relay node and the DeNB is the S1-AP protocol, and the communication protocol between the DeNB and the MME is also the S1-AP protocol.

The Relay node may also be attached to the network as a UE and it cannot be connected to a UE. The communication protocol between the Relay node and the DeNB is the air interface protocol and the communication protocol between the DeNB and the MME is the S1-AP protocol.

In the process of implementing the present invention, the inventor finds at least the following problem in the prior art. On a network, the communication protocols between a DeNB and Relay nodes whose identities are different. However, currently the DeNB cannot implement different service processing for the Relay nodes whose identities are different.

### SUMMARY OF THE INVENTION

To enable a DeNB to implement different service processing for Relay nodes whose identities are different, the present invention provides a method, a base station, a mobility management entity, and a system for implementing service processing.

A method for implementing service processing includes, acquiring the type of a subscribed user, if the type of the subscribed user is a UE, sending an S1-AP response message to a Relay node and using an AS (Access Stratum, access stratum) security mechanism and/or a network domain security mechanism with the Relay node and if the type of the subscribed user is a relay base station Relay, initiating a radio resource control RRC (Radio Resource Control, radio resource control) reconfiguration process with the Relay node and using the AS security mechanism with the Relay node.

A base station includes acquiring module configured to acquire the type of a subscribed user, first implementation module, configured to the type of the subscribed user is a UE, send an S1-AP response message to a Relay node and use an AS security mechanism and/or a network domain security mechanism with the Relay node and a second implementation module, configured to, if the type of the subscribed user is a relay base station Relay, initiate an RRC reconfiguration process with the Relay node and use the AS security mechanism with the Relay node.

A mobility management entity MME includes a second acquiring module, configured to acquire the type of a subscribed user and sending module, configured to send the type of the subscribed user to a base station, so that when the type of the subscribed user is a UE, the base station sends an S1-AP response message to a Relay node and uses an AS security mechanism and/or a network domain security mechanism with the Relay node; when the type of the subscribed user is a Relay, the base station initiates an RRC reconfiguration process with the Relay node and uses the AS security mechanism with the Relay node.

A system for implementing service processing includes a base station and a mobility management entity, where the mobility management entity is configured to acquire the type of a subscribed user and send the type of the subscribed user to the base station and the base station is configured to, if the type of the subscribed user is a UE, send an S1-AP response message to a Relay node and use an AS security mechanism and/or a network domain security mechanism with the Relay node; if the type of the subscribed user is a Relay, initiate an RRC reconfiguration process with the Relay node and use the AS security mechanism with the Relay node.

The type of a subscribed user is acquired. If the type of the subscribed user is a UE, implementing service processing is sending an S1-AP response message to a Relay node and using an AS security mechanism and/or a network domain security mechanism with the Relay node; if the type of the subscribed user is a Relay, the implementing service processing is initiating an RRC reconfiguration process with a Relay node and using the AS security mechanism with the Relay node. When the type of the subscribed user is a UE, the Relay node is deployed on a network as a base station; when the type of the subscribed user is a Relay, the Relay node is attached to the network as a UE. In this way, base station implements different services processing for Relay nodes whose identities are different.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a schematic diagram of first network architecture used in Embodiment 1 of the present invention;

FIG. 2 is a schematic diagram of second network architecture used in Embodiment 1 of the present invention;

FIG. 3 is a flow chart of a method for implementing service processing according to Embodiment 1 of the present invention;

FIG. 4 is a flow chart of a method for implementing service processing according to Embodiment 2 of the present invention;

FIG. 5 is a flow chart of a method for implementing service processing according to Embodiment 3 of the present invention;

FIG. 6 is a flow chart of a method for implementing service processing according to Embodiment 4 of the present invention;

FIG. 7 is a flow chart of a method for implementing service processing according to Embodiment 5 of the present invention;

FIG. 8 is a flow chart of a method for implementing service processing according to Embodiment 6 of the present invention;

FIG. 9 is a flow chart of a method for implementing service processing according to Embodiment 7 of the present invention;

FIG. 10 is a flow chart of a method for implementing service processing according to Embodiment 8 of the present invention;

FIG. 11 is a flow chart of a method for implementing service processing according to Embodiment 9 of the present invention;

FIG. 12 is a schematic diagram of a base station according to Embodiment 10 of the present invention;

FIG. 13 is a schematic diagram of a mobility management entity according to Embodiment 11 of the present invention; and

FIG. 14 is a schematic diagram of a system for implementing service processing according to Embodiment 12 of the present invention.

### DETAILED DESCRIPTION OF ILLUSTRATIVE EMBODIMENTS

To make the objectives, technical solutions, and advantages of the present invention more comprehensible, the following describes the embodiments of the present invention in further detail below with reference to the accompanying drawings.

### Embodiment 1

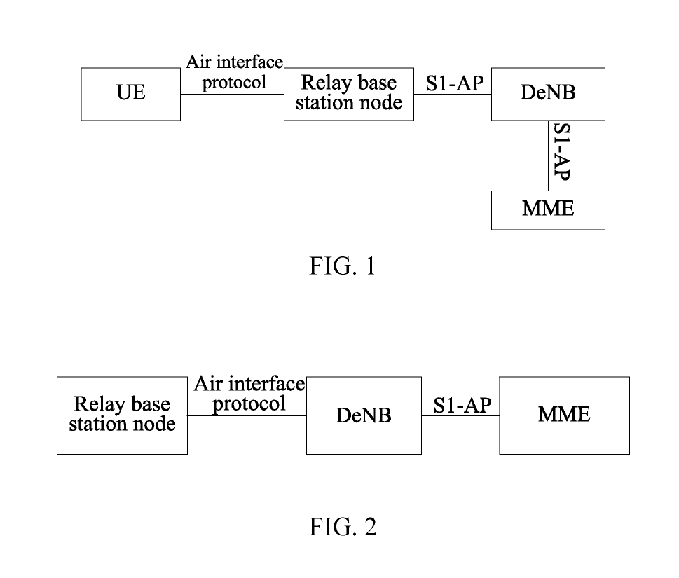

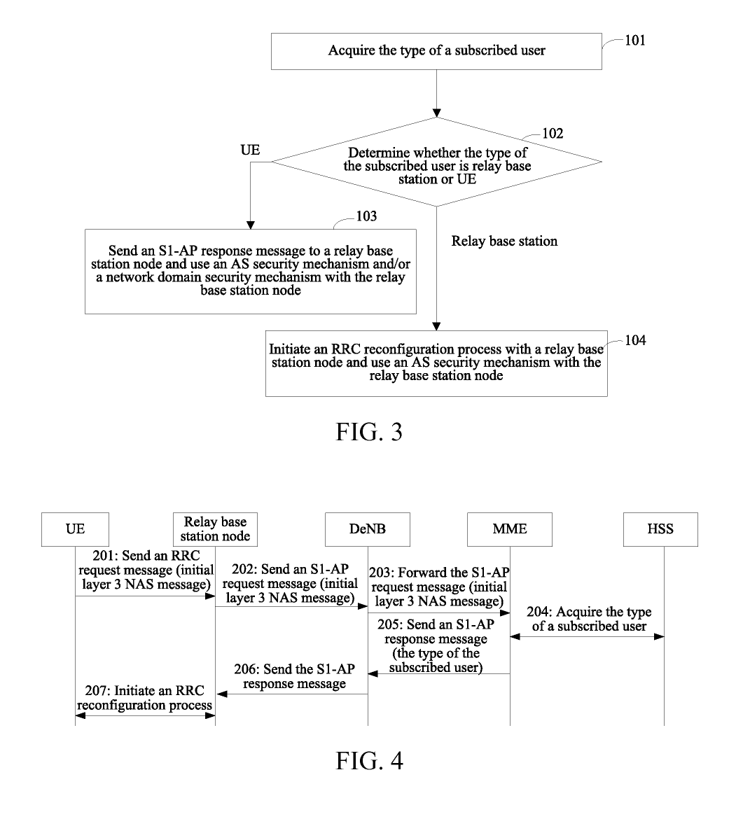

This embodiment of the present invention provides a method for implementing service processing. This embodiment may apply to the network architecture shown in FIG. 1 or the network architecture shown in FIG. 2. On the network architecture shown in FIG. 1, a Relay node is deployed on a network as a base station. On the network architecture shown in FIG. 2, a Relay node is attached to a network as a UE. As shown in FIG. 3, this method includes the following steps.

Step 101: Acquire the type of a subscribed user.

Step 102: Determine whether the acquired type of the subscribed user is a Relay or a UE. If the type of the subscribed user is a UE, perform step 103; if the type of the subscribed user is a Relay, perform step 104.

Step 103: Send an S1-AP response message to a Relay node and use an AS security mechanism and/or a network domain security mechanism with the Relay node.

Step 104: Initiate an RRC reconfiguration process with a Relay node and use the AS security mechanism with the Relay node.

In this embodiment, an executing entity may be a base station.

The S1-AP response message may be an Initial Context Setup request (context setup request).

In the method according to this embodiment of the present invention, the type of a subscribed user is acquired. If the type of the subscribed user is a UE, implementing service processing is sending an S1-AP response message to a Relay node and using an AS security mechanism (such as an RRC integrity protection/encryption protection, a UP (User Plane, user plane) encryption protection security mechanism) and/or a network domain security mechanism with the Relay node; if the type of the subscribed user is a Relay, the implementing service processing is initiating an RRC reconfiguration process with a Relay node and using the AS security mechanism with the Relay node. When the type of the subscribed user is a UE, the Relay node is deployed on a network as a base station; when the type of the subscribed user is a Relay, the Relay node is attached to the network as a UE. In this way, a DeNB implements different service processing for Relay nodes whose identities are different.

### Embodiment 2

This embodiment of the present invention provides a method for implementing service processing. This embodiment applies to the network architecture shown in FIG. 1. The type of a subscribed user on a network is a UE, and an MME acquires the type of the subscribed user from an HSS. As shown in FIG. 4, this method includes the following steps.

Step 201: A UE sends an RRC request message to a Relay node, where the RRC request message carries an initial layer 3 NAS message, the initial layer 3 NAS (Non Access Stratum, non-access stratum) message includes at least the identity of the UE, and the initial layer 3 NAS message may be an Attach request (attach request) or a TAU request (Tracking Area Update request, tracking area update request).

Before sending the RRC request message, the UE adds its own identity to the initial layer 3 NAS message carried in the RRC request message.

In this embodiment, an IMSI (International Mobile Subscriber Identity, international mobile subscriber identity), a GUTI (Globally Unique Temporary Identity, global unique temporary identity), or an IMEI (International Mobile Equipment identity, international mobile equipment identity) may be served as the identity.

Step 202: After receiving the RRC request message, the Relay node sends an S1-AP request message to a DeNB, where the S1-AP request message carries the initial layer 3 NAS message carried in the RRC request message.

After receiving the RRC request message, the Relay node extracts the initial layer 3 NAS message carried in the RRC request message and then generates the S1-AP request message carrying the initial layer 3 NAS message.

The S1-AP request message may be an Initial UE message (initial UE message).

Step 203: The DeNB receives the S1-AP request message and forwards the S1-AP request message to an MME.

Step 204: The MME receives the S1-AP request message, extracts an identity from the initial layer 3 NAS message carried in the S1-AP request message, and acquires the type of a subscribed user corresponding to the extracted identity, where the acquired type of the subscribed user is a UE.

Specifically, the MME receives the S1-AP request message, extracts the identity from the initial layer 3 NAS message carried in the S1-AP request message, and acquires the type of the subscribed user from an HSS (Home Subscriber Server, home subscriber server) according to the extracted identity.

The operation that the MME extracts the type of the subscribed user from the HSS according to the extracted identity is specifically as follows.

The MME sends the extracted identity to the HSS. The HSS receives the identity; searches for the corresponding type of the subscribed user from the correspondence between an identity and the type of the subscribed user according to the received identity, where the correspondence is stored in the HSS; and sends the found type of the subscribed user to the MME.

A carrier subscribes with each UE on a network in advance, and the type of a subscribed user who subscribes with the UE is a UE. Then, the carrier stores an identity of each UE and the type of the subscribed user of the UE in the correspondence between the identity and the type of the subscribed user in the HSS.

If the Relay node is deployed on the network as a base station, the Relay node can be connected to one or more UEs; if the Relay node is attached to the network as a UE, the Relay node cannot be connected to a UE and the Relay node has its own identity.

The carrier can subscribe with a Relay node whose identity is a UE, where the type of the subscribed user who subscribes with the Relay node is a Relay; and the carrier stores the identity of the Relay node and the type Relay of the subscribed user of the Relay node in the correspondence between the identity and the type of the subscribed user in the HSS.

In this embodiment, if the type of the subscribed user is a UE, it indicates that the Relay node is connected to a UE, and therefore the Relay node is deployed on the network as a base station; if the type of the subscribed user is a Relay, it indicates that the Relay node is attached to the network as a UE.

Step 205: The MME sends an S1-AP response message to the DeNB, where the S1-AP response message carries the acquired type of the subscribed user.

The S1-AP response message may be an Initial Context Setup request.

Step 206: The DeNB receives the S1-AP response message, sends the S1-AP response message to the Relay node according to the type UE of the subscribed user carried in the S1-AP response message, and uses an AS security mechanism and/or a network domain security mechanism between the DeNB and the Relay node.

Further, the DeNB may also determine that the identity of the Relay node is a base station according to the type UE of the subscribed user.

The AS security mechanism may be an RRC integrity protection/encryption protection and an UP encryption protection.

Step 207: The Relay node receives the S1-AP response message and initiates an

RRC reconfiguration process between the UE and the Relay node.

In the method according to this embodiment of the present invention, an MME acquires the type UE of a subscribed user from an HSS and sends it to a DeNB. The DeNB receives the type of the subscribed user. When the type of the subscribed user is a UE, a Relay node is deployed on a network as a base station. Therefore, according to the type UE of the subscribed user, the DeNB implements service processing: sending an S1-AP response message to the Relay node and using an AS security mechanism and/or a network domain security mechanism between the DeNB and the Relay node.

### Embodiment 3

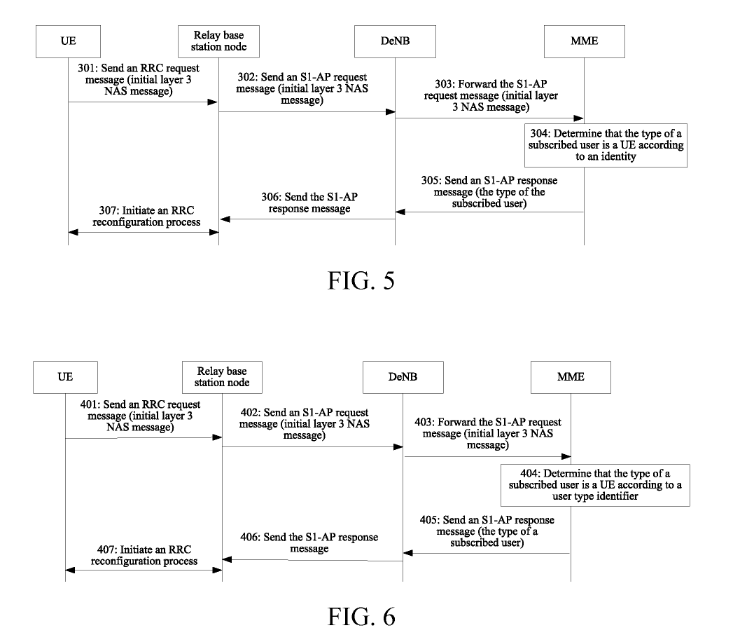

This embodiment of the present invention provides a method for implementing service processing. This embodiment applies to the network architecture shown in FIG. 1. The type of a subscribed user on a network is a UE, and an MMS determines the type of the subscribed user according to an identity. As shown in FIG. 5, this method includes the following steps.

Steps 301-303 are the same as steps 201-203 in Embodiment 2, and details are not provided herein.

Step 304: The MME receives the S1-AP request message from the DeNB, extracts an identity from the initial layer 3 NAS message carried in the S1-AP request message, and determines that the type of the subscribed user is a UE according to the identity.

Specifically, the MME receives the S1-AP request message from the DeNB, extracts the identity from the initial layer 3 NAS message carried in the S1-AP request message, and determines the type of the subscribed user according to a range where the extracted identity is located.

When allocating an identity to each Relay node whose identity is a UE on a network, a carrier allocates an identity of each Relay node whose identity is a UE within a specified range. When allocating an identity to each UE on the network, the carrier allocates an identity of each UE beyond the specified range. Alternatively, when allocating an identity to each UE on the network, the carrier allocates an identity of each UE within a specified range and allocates an identity of each Relay node whose identity is a UE beyond the specified range.

Accordingly, the operation of determining the type of the subscribed user according to the range where the extracted identity is located is specifically as follows.

Determining whether the extracted identity is within the specified range, where if yes, the type of the subscribed user corresponding to the extracted identity is a Relay; if no, the type of the subscribed user corresponding to the extracted identity is a UE or determining whether the extracted identity is beyond the specified range, where if yes, the type of the subscribed user corresponding to the extracted identity is a Relay; if no, the type of the subscribed user corresponding to the extracted identity is a UE.

The S1-AP request message may be an Initial UE message.

Steps 305-307 are the same as steps 205-207 in Embodiment 2, and details are not provided herein.

In the method according to this embodiment of the present invention, an MME determines that the type of a subscribed user is a UE according to an identity and sends the type of the subscribed user to a DeNB. When the type of the subscribed user is a UE, a Relay node is deployed on a network as a base station. Therefore, according to the type UE of the subscribed user, the DeNB implements service processing: sending an S1-AP response message to the Relay node and using an AS security mechanism and/or a network domain security mechanism between the DeNB and the Relay node.

### Embodiment 4

This embodiment of the present invention provides a method for implementing service processing. This embodiment applies to the network architecture shown in FIG. 1. The type of a subscribed user on the network is a UE, and an MME determines the type of the subscribed user according to a user type identifier. As shown in FIG. 6, this method includes the following steps.

Step 401: A UE sends an RRC request message to a Relay node, where the RRC request message carries an initial layer 3 NAS message, and the initial layer 3 NAS message includes at least the user type identifier of the UE.

Before sending the RRC request message, the UE adds its own user type identifier to the initial layer 3 NAS message carried in the RRC request message. In this embodiment, the user type identifier is used to identify the type of a subscribed user as a UE.

The initial layer 3 NAS message may be an Attach request or a TAU request.

Steps 402 and 403 are the same as steps 202 and 203 in Embodiment 2, and details are not provided herein.

Step 404: The MME receives the S1-AP request message from the DeNB, extracts the user type identifier from the initial layer 3 NAS message carried in the S1-AP request message, and determines that the type of a subscribed user is a UE according to the extracted user type identifier.

The S1-AP request message may be an Initial UE message.

Steps 405-407 are the same as steps 205-207 in Embodiment 2, and details are not provided herein.

In the method according to this embodiment of the present invention, an MME determines that the type of a subscribed user is a UE according to a user type identifier and sends the type of the subscribed user to a DeNB. When the type of the subscribed user is a UE, a Relay node is deployed on a network as a base station. Therefore, according to the type UE of the subscribed user, the DeNB implements service processing: sending an S1-AP response message to the Relay node and using an AS security mechanism and/or a network domain security mechanism between the DeNB and the Relay node. The DeNB may also determine that the identity of the Relay node is a base station according to the type UE of the subscribed user.

### Embodiment 5

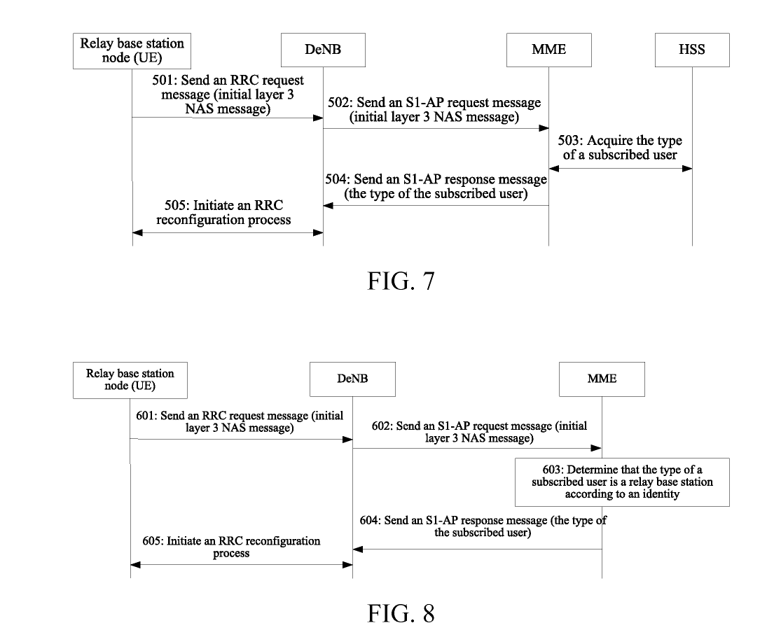

This embodiment of the present invention provides a method for implementing service processing. This embodiment applies to the network architecture shown in FIG. 2. The type of a subscribed user on the network is a Relay, and an MME acquires the type of the subscribed user from an HSS. As shown in FIG. 7, this method includes the following steps.

Step 501: A Relay node sends an RRC request message to a DeNB, where the RRC request message carries an initial layer 3 NAS message, and the initial layer 3 NAS message includes at least the identity of the Relay node when the Relay node is a UE.

Before sending the RRC request message, the Relay node adds its own identity to an initial layer 3 NAS message carried in the RRC request message.

The initial layer 3 NAS message may be an Attach request or a TAU request.

Step 502: After receiving the RRC request message, the DeNB sends an S1-AP request message to an MME, where the S1-AP request message carries the initial layer 3 NAS message carried in the RRC request message.

The DeNB extracts the initial layer 3 NAS message from the RRC request message and generates an S1-AP request message carrying the initial layer 3 NAS message.

The S1-AP request message may be an Initial UE message.

Step 503: The MME receives the S1-AP request message, extracts the identity from the initial layer 3 NAS message carried in the S1-AP request message, and acquires the type Relay of a subscribed user corresponding to the extracted identity.

Specifically, the MME receives the S1-AP request message, extracts the identity from the initial layer 3 NAS message carried in the S1-AP request message, and acquires the type Relay of a subscribed user from an HSS according to the extracted identity.

The operation of acquiring the type of the subscribed user from the HSS according to the extracted identity is specifically as follows.

The MME sends the extracted identity to the HSS. The HSS receives the identity; searches for the corresponding type of the subscribed user from the correspondence between an identity and the type of the subscribed user according to the received identity, where the correspondence is stored in the HSS and the found type of the subscribed user is a Relay in this embodiment; and sends the found type of the subscribed user to the MME.

Step 504: The MME sends an S1-AP response message to the DeNB, where the S1-AP response message carries the acquired type of the subscribed user.

The S1-AP response message may be an Initial Context Setup request.

Step 505: The DeNB receives the S1-AP response message, initiates an RRC reconfiguration process between the DeNB and the Relay node according to the type Relay of the subscribed user carried in the S1-AP response message, and uses an AS security mechanism between the DeNB and the Relay node.

Further, the DeNB may also determine that the identity of the Relay node is a UE according to the type Relay of the subscribed user.

When determining that the type of the subscribed user is a Relay, the DeNB determines that the Relay node is attached to the network as a UE.

In the method according to this embodiment of the present invention, an MME acquires the type Relay of a subscribed user from an HSS and sends it to a DeNB. The DeNB receives the type of the subscribed user. When the type of the subscribed user is a Relay, a Relay node is attached to a network as a UE. Therefore, according to the type Relay of the subscribed user, the DeNB implements service processing: initiating an RRC reconfiguration process between the DeNB and the Relay node and using an AS security mechanism between the DeNB and the Relay node.

### Embodiment 6

This embodiment of the present invention provides a method for implementing service processing. This embodiment applies to the network architecture shown in FIG. 2. The type of a subscribed user on a network is a Relay, and an MME determines the type of the subscribed user according to an identity. As shown in FIG. 8, this method includes the following steps.

Steps 601 and 602 are the same as steps 501 and 502 in Embodiment 5, and details are not provided herein.

Step 603: The MME receives the S1-AP request message from the DeNB, extracts the identity from the initial layer 3 NAS message carried in the S1-AP request message, and determines that the type of the subscribed user is a Relay according to the extracted identity.

Specifically, the MME receives the S1-AP request message from the DeNB, extracts the identity from the initial layer 3 NAS message carried in the S1-AP request message, and determines the type of the subscribed user according to a range where the extracted identity is located. In this embodiment, the determined type of the subscribed user is a Relay.

The operation of determining the type of the subscribed user according to the range where the extracted identity is located is the same as the part of content in step 304 of Embodiment 3, and details are not provided herein.

The S1-AP request message may be an Initial UE message.

Steps 604 and 605 are the same as steps 504 and 505 in Embodiment 5, and details are not provided herein.

In the method according to this embodiment of the present invention, an MME determines that the type of a subscribed user is a Relay according to an identity and sends it to a DeNB. When the type of the subscribed user is a Relay, a Relay node is attached to a network as a UE. Therefore, according to the type Relay of the subscribed user, the DeNB implements service processing: initiating an RRC reconfiguration process between the DeNB and the Relay node and using an AS security mechanism between the DeNB and the Relay node.

### Embodiment 7

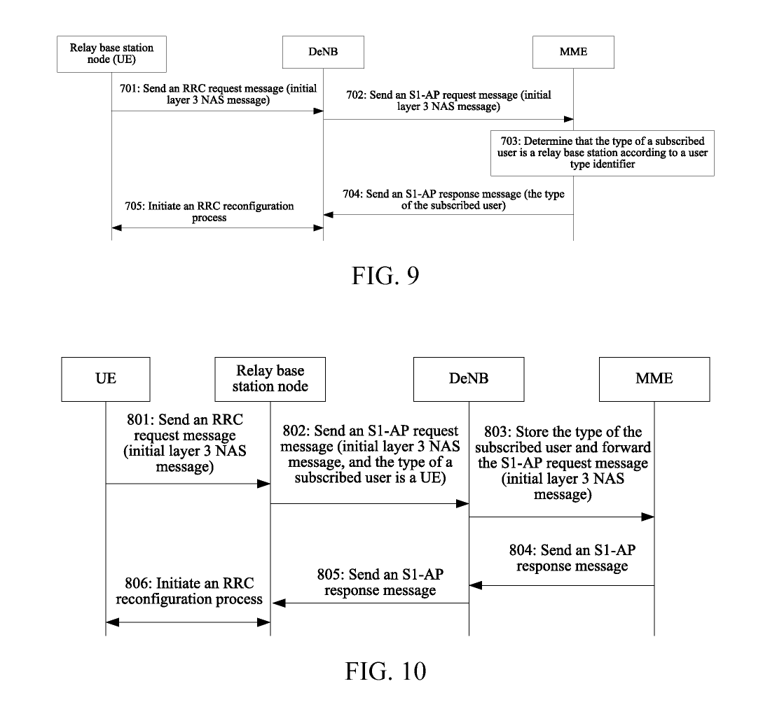

This embodiment of the present invention provides a method for implementing service processing. This embodiment applies to the network architecture shown in FIG. 2. The type of a subscribed user on the network is a Relay, and an MME determines the type of the subscribed user according to a user type identifier. As shown in FIG. 9, this method includes the following steps.

Step 701: A Relay node sends an RRC request message to a DeNB, where the RRC request message carries an initial layer 3 NAS message, and the initial layer 3 NAS message includes at least the user type identifier of the Relay node.

Before sending the RRC request message, the Relay node adds its own user type identifier to the initial layer 3 NAS message carried in the RRC request message. In this embodiment, the user type identifier is used to identify the type of the subscribed user as a Relay.

The initial layer 3 NAS message may be an Attach request or a TAU request.

Step 702 is the same as step 502 in Embodiment 5, and details are not provided herein.

Step 703: The MME receives the S1-AP request message sent by the DeNB, extracts the user type identifier from the initial layer 3 NAS message carried in the S1-AP request message, and determines that the type of the subscribed user is a Relay according to the extracted user type identifier.

The S1-AP request message may be an Initial UE message.

Steps 704 and 705 are the same as steps 504 and 505 in Embodiment 5, and details are not provided herein.

In the method according to this embodiment of the present invention, an MME determines that the type of a subscribed user is a Relay according to a user type identifier and sends it to a DeNB. When the type of the subscribed user is a Relay, a Relay node is attached to a network as a UE. Therefore, according to the type Relay of the subscribed user, the DeNB implements service processing: initiating an RRC reconfiguration process between the DeNB and the Relay node and using an AS security mechanism between the DeNB and the Relay node.

### Embodiment 8

This embodiment of the present invention provides a method for implementing service processing. This embodiment applies to the network architecture shown in FIG. 1. A DeNB receives the type of a subscriber user sent by a Relay node and the type of the subscribed user is a UE. As shown in FIG. 10, this method includes the following steps.

Step 801: A UE sends an RRC request message, where the RRC request message carries an initial layer 3 NAS message.

The initial layer 3 NAS message may be an Attach request or a TAU request.

Step 802: A Relay node receives the RRC request message and sends an S1-AP request message to a DeNB.

The S1-AP request message carries the type UE of a subscribed user and the initial layer 3 NAS message carried in the RRC request message.

The Relay node extracts the initial layer 3 NAS message from the RRC request message and generates an S1-AP request message carrying the type UE of the subscribed user and the initial layer 3 NAS message.

The S1-AP request message may be an Initial UE message.

Step 803: The DeNB receives the S1-AP request message, extracts the type of the subscribed user from the S1-AP request message, stores the type of the subscribed user, and sends, to an MME, the S 1-AP request message carrying the initial layer 3 NAS message.

Step 804: The MME receives the S1-AP request message and sends an S1-AP response message to the DeNB.

Step 805: The DeNB receives the S1-AP response message from the MME, forwards the S1-AP response message to the Relay node according to the stored type UE of the subscribed user, and uses an AS security mechanism and/or a network domain security mechanism between the DeNB and the Relay node.

Further, the DeNB may also determine that the identity of the Relay node is a base station according to the type UE of the subscribed user.

The AS security mechanism may be an RRC integrity protection/encryption protection and an UP encryption protection.

The S1-AP response message may be an Initial Context Setup request.

Step 806: The Relay node receives the S1-AP response message and initiates an RRC reconfiguration process between the UE and the Relay node according to the S1-AP response message.

In the method according to this embodiment of the present invention, a DeNB receives and stores the type of a subscribed user sent by a Relay node, where the type of the subscribed user is a UE. When the type of the subscribed user is a UE, the Relay node is deployed on a network as a base station. Therefore, according to the type UE of the subscribed user, the DeNB implements service processing: sending an S1-AP response message to the Relay node and using an AS security mechanism and/or a network domain security mechanism between the DeNB and the Relay node.

### Embodiment 9

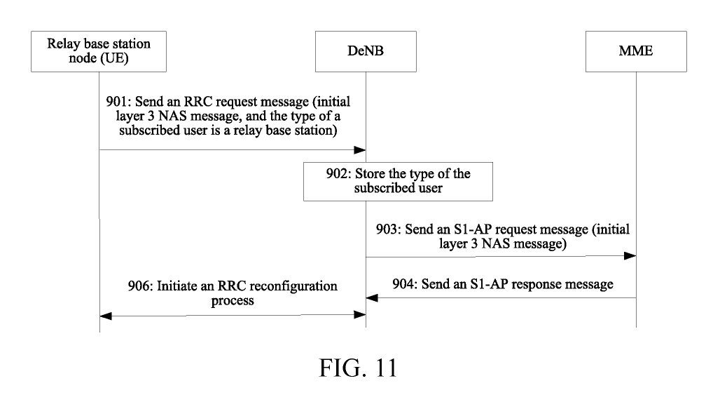

This embodiment of the present invention provides a method for implementing service processing. This embodiment applies to the network architecture shown in FIG. 2. A DeNB receives the type of a subscriber user sent by a Relay node and the type of the subscribed user is a Relay. As shown in FIG. 11, this method includes the following steps.

Step 901: A Relay node sends an RRC request message to a DeNB, where the RRC request message carries the type Relay of a subscribed user and an initial layer 3 NAS message.

The initial layer 3 NAS message may be an Attach request or a TAU request.

Step 902: The DeNB receives the RRC request message, extracts the type of the subscribed user from the RRC request message, and stores the type of the subscribed user.

The S1-AP request message may be an Initial UE message.

Step 903: The DeNB sends an S1-AP request message to an MME, where the S1-AP request message carries the initial layer 3 NAS message carried in the RRC request message.

The DeNB extracts the initial layer 3 NAS message from the RRC request message and generates an S1-AP request message carrying the extracted initial layer 3 NAS message.

Step 904: The MME receives the S1-AP request message and sends an S1-AP response message to the DeNB.

The S1-AP response message may be an Initial Context Setup request.

Step 905: The DeNB receives the S1-AP response message sent by the MME, initiates an RRC reconfiguration process between the DeNB and a Relay node according to the stored type Relay of the subscribed user, and uses an AS security mechanism between the DeNB and the Relay node.

Further, the DeNB may also determine that the identity of the Relay node is a UE according to the type Relay of the subscribed user.

In the method according to this embodiment of the present invention, a DeNB receives and stores the type of a subscribed user sent by a Relay node, where the type of the subscribed user is a Relay. According to the type Relay of the subscriber user, the DeNB implements service processing initiating an RRC reconfiguration process between the DeNB and the Relay node and uses an AS security mechanism with the Relay node.

### Embodiment 10

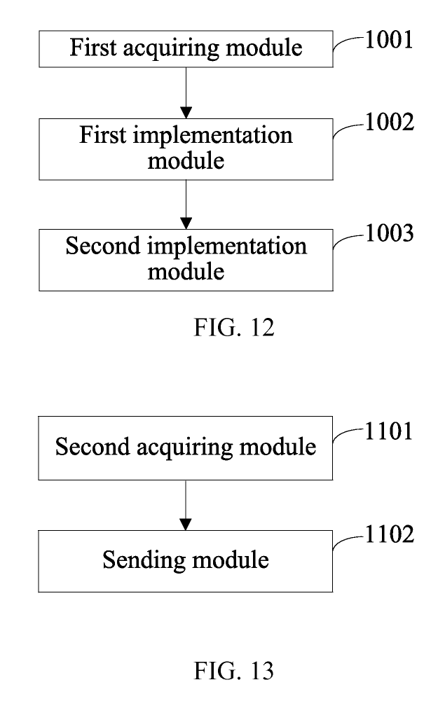

As shown in FIG. 12, an embodiment of the present invention provides a base station. A first acquiring module 1001 is configured to acquire the type of a subscribed user. A first implementation module 1002 is configured to, if the type of the subscribed user is a UE, send an S1-AP response message to a Relay node, to and use an AS security mechanism and/or a network domain security mechanism with the Relay node. A second implementation module 1003 is configured to, if the type of the subscribed user is a Relay, initiate an RRC reconfiguration process with a Relay node and use an AS security mechanism with the Relay node.

The acquiring module 1001 includes a receiving unit, configured to receive the type of a subscribed user sent by an MME or receive the type of a subscribed user sent by a Relay node.

The receiving unit is specifically configured to receive an S1-AP request message sent by the Relay node and extract the type of the subscribed user from the S1-AP request message or receive an RRC request message sent by the Relay node and extract the type of the subscribed user from the RRC request message.

An S1-AP response message is used to trigger an RRC reconfiguration process between the Relay node and a UE.

The AS security mechanism includes an RRC integrity protection, an RRC encryption protection and an UP encryption protection.

An initial layer 3 NAS message may be an Attach request or a TAU request, the S1-AP request message may be an Initial UE message, and the S1-AP response message may be an Initial Context Setup request.

In this embodiment, a base station acquires the type of a subscribed user. If the type of the subscribed user is a UE, implementing service processing is sending an S1-AP response message to a Relay node and using an AS security mechanism and/or a network domain security mechanism between the base station and the Relay node, if the type of the subscribed user is a Relay, the implementing service processing is initiating an RRC reconfiguration process between the base station and the Relay node and using an AS security mechanism between base station and the Relay node. When the type of the subscribed user is a UE, the Relay node is deployed on a network as a base station when the type of the subscribed user is a Relay; the Relay node is attached to the network as a UE. In this way, a base station implements different service processing for Relay nodes whose identities is different.

### Embodiment 11

As shown in FIG. 13, an embodiment of the present invention provides a mobility management entity MME. A second acquiring module 1101 is configured to acquire the type of a subscribed user. A sending module 1102 is configured to send the type of the subscribed user to a base station, so that when the type of the subscribed user is a UE, the base station sends an S1-AP response message to a Relay node and uses an AS security mechanism and/or a network domain security mechanism between the base station and the Relay node. When the type of the subscribed user is a Relay, the base station initiates an RRC reconfiguration process between the base station and the Relay node and uses an AS security mechanism between the base station and the Relay node.

The MME further includes a receiving module, configured to receive an initial layer 3 non access stratum NAS message where accordingly, the second acquiring module 1101 includes an acquiring unit, configured to acquire the type of a subscribed user from an HSS according to an identity in the initial layer 3 NAS message, where the HSS is configured to store the correspondence between the identity and the type of the subscribed user or a first determining unit, configured to determine the type of the subscribed user according to a range where the identity in the initial layer 3 NAS is located, where the identity of a UE and the identity of a Relay node are in different ranges or a second determining unit, configured to determine the type of the subscribed user according to a user type identifier in the initial layer 3 NAS message, where the user type identifier is added by the UE or the Relay node.

The initial layer 3 NAS message may be an Attach request or a TAU request.

In this embodiment, an MME acquires the type of a subscribed user and sends the acquired type of the subscribed user to a base station, so that when the type of the subscribed user is a UE, the base station sends an S1-AP response message to a Relay node and uses an AS security mechanism and/or a network domain security mechanism between the base station and the Relay node; when the type of the subscribed user is a Relay, the base station initiates an RRC reconfiguration process between the base station and the Relay node and uses an AS security mechanism between the base station and the Relay node. When the type of the subscribed user is a UE, the Relay node is deployed on a network as a base station; when the type of the subscribed user is a Relay, the Relay node is attached to the network as a UE. Therefore, the base station is capable of implementing different service processing for Relay nodes whose identities are different.

### Embodiment 12

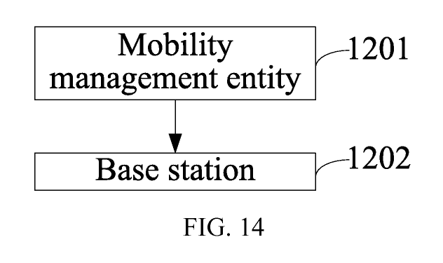

As shown in FIG. 14, this embodiment of the present invention provides a system for implementing service processing, including a base station 1202 and a mobility management entity 1201 where the mobility management entity 1201 is configured to acquire the type of a subscribed user and send the acquired type of the subscribed user to the base station 1202 and the base station 1202 is configured to receive the type of a subscribed user, if the type of the subscriber user is a UE, send an S1-AP response message to a Relay node and use an AS security mechanism and/or a network domain security mechanism between the base station and the Relay node; if the type of the subscribed user is a Relay, initiate an RRC reconfiguration process between the base station and the Relay node and use an AS security mechanism between the base station and the Relay node.

The S1-AP response message may be an Initial Context Setup request.

In the system according to this embodiment of the present invention, a mobility management entity acquires the type of a subscribed user and sends it to a base station. The base station receives the type of the subscribed user sent by the mobility management entity. If the type of the subscribed user is a UE, the base station implements service processing: sending an S1-AP response message to a Relay node and using an AS security mechanism and/or a network domain security mechanism between the base station and the Relay node; if the type of the subscribed user is a Relay, the base station implements service processing: initiating an RRC reconfiguration process between the base station and the Relay node and using an AS security mechanism between the base station and the Relay node. When the type of the subscribed user is a UE, the Relay node is deployed on a network as a base station; when the type of the subscribed user is a Relay, the Relay node is attached to a network as a UE. In this way, a base station implements different service processing for Relay nodes whose identities is different.

All or part of the content in the technical solutions provided in the foregoing embodiments may be implemented by software programs, and the software programs are stored in readable storage media such as a hard disk, an optical disk, or a floppy disk in a computer.

The foregoing description is merely about the exemplary embodiments of the present invention and is not intended to limit the present invention. Any modification, equivalent replacement, or improvement made without departing the idea and principle of the present invention shall fall within the protection scope of the present invention.

What is claimed is:

1. A method for implementing service processing, the method comprising:
acquiring, by a base station, a type of a subscribed user;
if the type of the subscribed user is a UE, sending, by the base station, an S1-AP response message to a Relay node and using, by the base station, an access stratum (AS) security mechanism and/or a network domain security mechanism between the base station and the Relay node; and
if the type of the subscribed user is a relay base station (Relay) node, initiating, by the base station, a radio resource control (RRC) reconfiguration process between the base station and the Relay node and using an AS security mechanism between the base station and the Relay node.

2. The method according to claim 1, wherein acquiring the type of the subscribed user comprises receiving, by the base station, the type of the subscribed user sent by a mobility management entity.

3. The method according to claim 2, wherein the type of the subscribed user sent by the mobility management entity is acquired by the mobility management entity from a home subscriber server (HSS) according to an identity in an initial layer 3 non access stratum (NAS) message and the HSS is configured to store correspondence between the identity and the type of the subscribed user.

4. The method according to claim 2, wherein the type of the subscribed user sent by the mobility management entity is determined by the mobility management entity according to a range where an identity in an initial layer 3 NAS message is located and an identity of the UE and an identity of the Relay node are in different ranges.

5. The method according to claim 2, wherein the type of the subscribed user sent by the mobility management entity is determined by the mobility management entity according to a user type identifier in an initial layer 3 NAS message and the user type identifier is added by the UE or the Relay node.

6. The method according to claim 1, wherein acquiring the type of the subscribed user comprises receiving, by the base station, the type of the subscribed user sent by the Relay node.

7. The method according to claim 6, wherein receiving the type of the subscribed user sent by the Relay node comprises receiving an S1-AP request message sent by the Relay node and extracting the type of the subscribed user from the S1-AP request message.

8. The method according to claim 6, wherein receiving the type of the subscribed user sent by the Relay node comprises receiving an RRC request message sent by the Relay node and extracting the type of the subscribed user from the RRC request message.

9. The method according to claim 1, wherein the S1-AP response message is used to trigger an RRC reconfiguration process between the Relay node and the UE.

10. The method according to claim 1, wherein the AS security mechanism comprises an RRC integrity protection, an RRC encryption protection, and a user plane (UP) encryption protection.

11. A base station, comprising:
a first acquiring module, configured to acquire a type of a subscribed user;
a first implementation module, configured to, if the type of the subscribed user is a user equipment (UE), send an S1-AP response message to a relay base station (Relay) node and use an access stratum (AS) security mechanism and/or a network domain security mechanism between the base station and the Relay node; and
a second implementation module, configured to, if the type of the subscribed user is a Relay node, initiate a radio resource control (RRC) reconfiguration process between the base station and the Relay node and use an AS security mechanism between the base station and the Relay node.

12. The base station according to claim 11, wherein the acquiring module comprises a receiving unit, configured to receive the type of the subscribed user sent by a mobility management entity or by the Relay node.

13. The base station according to claim 12, wherein the receiving unit is specifically configured to receive an S1-AP request message sent by the Relay node and to extract the type of the subscribed user from the S1-AP request message.

14. The base station according to claim 12, wherein the receiving unit is specifically configured to receive an RRC request message sent by the Relay node and extract the type of the subscribed user from the RRC request message.

15. The base station according to claim 11, wherein the S1-AP response message is used to trigger an RRC reconfiguration process between the Relay node and the UE.

16. The base station according to claim 11, wherein the AS security mechanism comprises an RRC integrity protection, an RRC encryption protection, and an UP encryption protection.

17. A system for implementing service processing the system, comprising:
a base station; and
a mobility management entity;
wherein the mobility management entity is configured to acquire a type of a subscribed user and send the type of the subscribed user to the base station; and
the base station is configured to, if the type of the subscribed user is a user equipment (UE), send an S1-AP response message to a relay base station (Relay) node and use an access stratum (AS) security mechanism and/or a network domain security mechanism between the base station and the Relay node and, if the type of the subscribed user is a Relay node, initiate a radio resource control (RRC) reconfiguration process between the base station and the Relay node and use an AS security mechanism between the base station and the Relay node.
